(19) United States
(12) Patent Application Publication
(10) Pub. No.: US 2015/0119491 A1
(43) Pub. Date: Apr. 30, 2015

(54) RUBBER COMPOSITION

(71) Applicant: TOYO TIRE & RUBBER CO., LTD., Osaka (JP)

(72) Inventor: Kazuya Hirabayashi, Osaka-shi (JP)

(73) Assignee: TOYO TIRE & RUBBER CO., LTD., Osaka (JP)

(21) Appl. No.: 14/303,135

(22) Filed: Jun. 12, 2014

(30) Foreign Application Priority Data
Oct. 25, 2013 (JP) 2013-222379

(51) Int. Cl. C08L 9/00; B60C 1/00; C08L 7/00

(52) U.S. Cl. CPC C08L 9/00; C08L 7/00; B60C 1/0025; B60C 1/0016; B60C 2001/0033
USPC 523/156; 524/526; 152/525

(57) ABSTRACT

A rubber composition includes a diene rubber containing at least a polybutadiene rubber produced by use of a rare earth element based catalyst; a carbon black in an amount of 10 to 99 parts by mass for 100 parts by mass of the diene rubber; and a dihydrazide compound in an amount of 0.1 to 5.0 parts by mass for the same.

### BACKGROUND OF THE INVENTION

1. Field of the Invention

The present invention relates to a rubber composition. This rubber composition is useful as a raw material of a vulcanized rubber excellent in low thermogenic performance and further in tackiness relative to a rubber of the same species or a different species.

2. Description of the Related Art

In recent years, developments of fuel-efficient tires have been actively made in the tire industry from the viewpoint of energy saving. It is said that for the fuel-efficient tire developments, it is indispensable to improve, in particular, the low thermogenic performance of rubber regions of tire treads that are obtained by vulcanization.

As a technique for improving a vulcanized rubber in low thermogenic performance, Patent Document 1 listed below describes a technique of blending a hydrazide compound and a reinforcing filler into a rubber composition as a raw material.

Additionally, Patent Document 2 listed below describes a technique, for developing a rubber composition for tire sidewalls that is capable of decreasing tires in rolling resistance to attain low fuel consumption, in which a specific carbon black is blended into 100 parts by mass of a rubber composed of 30 to 60% by mass of polybutadiene rubber obtained by polymerization using a neodymium based catalyst, and 70 to 40% by mass of another diene rubber.

### PRIOR ART DOCUMENTS

### Patent Documents

Patent Document 1: JP-A-4-136048

Patent Document 2: JP-A-2006-63284

### SUMMARY OF THE INVENTION

However, the present inventors have made eagerly investigated to make it evident that the above-mentioned precedent techniques each have problems. Specifically, according to the technique described in Patent Document 1, the low thermogenic performance of a vulcanized rubber to be obtained is not sufficiently improved. Furthermore, the tackiness thereof to a rubber of the same species or a different species is not investigated, either.

The technique described in Patent Document 2 is not concerned with any investigation about the tackiness of the rubber composition relative to a rubber of the same species or a different species.

In light of the actual situation, the present invention has been made. An object thereof is to provide a rubber composition which is to give a vulcanized rubber excellent in low thermogenic performance and is, in an unvulcanized state, excellent in tackiness relative to a rubber of the same species or a different species.

In order to solve the above-mentioned problems, the present inventors have eagerly investigated the following mechanism when a rubber composition is kneaded: a mechanism of the reaction of a diene rubber polymer and a carbon black with a dihydrazide compound in the composition. As a result, the present inventors have found out that: the dihydrazide compound can function as an intermediation to form bonds between the polymer and the carbon black in the diene rubber effectively; thus, the dispersibility of the carbon black is made good, and further in a case where the diene rubber contains a specific polybutadiene rubber, the rubber composition is improved in tackiness when at an unvulcanized rubber stage; and further the tackiness of the rubber composition is restrained from being lowered with the passage of time. The present invention has been accomplished on the basis of this finding.

Accordingly, the present invention relates to a rubber composition including: a diene rubber containing at least a polybutadiene rubber produced by use of a rare earth element based catalyst; a carbon black in an amount of 10 to 99 parts bymass for 100 parts bymass of the diene rubber; and a dihydrazide compound in an amount of 0.1 to 5.0 parts by mass for the same.

In a case where a rubber composition contains, for 100 parts by mass of its diene rubber, 10 to 99 parts by mass of a carbon black, and 0.1 to 5.0 parts by mass of a dihydrazide compound, polymer radicals are generated in the diene rubber when the individual components are kneaded. The polymer radicals react rapidly with the dihydrazide compound. At the time of this reaction, the presence of the carbon black causes the dihydrazide compound to function as an intermediation to generate bonds between the polymer in the diene rubber and the carbon black effectively. In this way, the dispersibility of the carbon black becomes very good. As a result, a vulcanized rubber to be obtained is improved in low thermogenic performance. Furthermore, when the rubber composition contains, as the diene rubber, at least a polybutadiene rubber produced by use of a rare earth element based catalyst, the vulcanized rubber to be obtained is further improved in low thermogenic performance and additionally the dispersibility of the carbon black is further heightened. By a synergetic effect thereof, the rubber composition is improved in tackiness relative to a rubber of the same species or a different species when in an unvulcanized rubber state. Moreover, the rubber composition can be further restrained from being lowered in tackiness with the passage of time.

In this rubber composition, it is preferred that 10 to 80 parts by mass of the polybutadiene rubber are contained in 100 parts by mass of the diene rubber. By adjusting, into the specified range, the blend amount of the polybutadiene rubber produced by use of the rare earth element based catalyst, the rubber composition is further improved in tackiness relative to a rubber of the same species or a different species when in an unvulcanized rubber state. Moreover, the rubber composition can be still further restrained from being lowered in tackiness with the passage of time.

In the rubber composition, the rare earth element based catalyst is preferably a neodymium based catalyst. The use of the polybutadiene rubber produced by use of the neodymium based catalyst makes an improvement, with a good balance, in the low thermogenic performance of the vulcanized rubber and the tackiness of the rubber composition at the unvulcanized rubber-stage.

The present invention also relates to a pneumatic tire obtained by use of the just above described rubber composition. The pneumatic tire obtained by use of the rubber composition as a raw material has a low thermogenic performance, so that the tire is improved very much in fuel economy performance. Furthermore, a member in which this rubber composition is used is excellent in tackiness relative to a different member; accordingly, the pneumatic tire is excellent in endurance. Thus, the rubber composition of the present invention is particularly useful as a raw material of a cap tread, a base tread, a sidewall and a rim strip of a pneumatic tire, and a side pad of a run flat tire.

### DETAILED DESCRIPTION OF THE PREFERRED EMBODIMENTS

The rubber composition according to the present invention includes: a diene rubber containing at least a polybutadiene rubber produced by use of a rare earth element based catalyst; a carbon black in an amount of 10 to 99 parts by mass for 100 parts by mass of the diene rubber; and a dihydrazide compound in an amount of 0.1 to 5.0 parts by mass for the same.

The rubber composition according to the present invention contains, as its diene rubber, at least a polybutadiene rubber (BR) produced by use of a rare earth element based catalyst. Examples of the rare earth element include scandium; yttrium; and lanthanoid elements such as lanthanum, cerium, praseodymium, neodymium, promethium, samarium, europium, gadolinium, terbium, dysprosium, holmium, erbium, thulium, ytterbium, and lutetium. Of these elements, neodymium is preferred; thus, in the present invention, a neodymium based catalyst is preferably usable. Example of the neodymium based catalyst include a simple substance of neodymium; compounds each composed of neodymium and another metal; and neodymium-containing organic compounds. Specific examples thereof include NdCl₃, and Et-NdCl₂.

The polybutadiene rubber produced by use of the rare earth element based catalyst, particularly, the neodymium based catalyst generally has a microstructure in which the cis bond content by percentage is high and further the vinyl content by percentage is low. In the present invention, the microstructure of the polybutadiene rubber is not particularly limited, and is preferably a microstructure in which the content by percentage of cis-1,4 bonds is 95% or more, and the vinyl content by percentage is 1.8% or less. The content by percentage of the cis-1,4 bonds is more preferably 97% or more, and the vinyl content by percentage is more preferably 1.0% or less. The cis bond content by percentage and the vinyl content by percentage are each a value measured by use of a nuclear magnetic resonance spectroscope (NMR).

Examples of a usable diene rubber other than the polybutadiene rubber produced by use of the rare earth element based catalyst include natural rubber (NR), polyisoprene rubber (IR), polybutadiene rubber (BR) produced by use of a catalyst other than any rare earth element based catalyst, polystyrene butadiene rubber (SBR), chloroprene rubber (CR), and nitrile rubber (NBR). The following is also preferably usable: a rubber in which one or more terminals are modified (such as terminal-modified SBR) as the need arises, or a rubber in which an original rubber is modified to impart a desired property thereto (such as modified NR).

In the rubber composition according to the present invention, it is preferred that 10 to 80 parts by mass of the polybutadiene rubber produced by use of the rare earth element based catalyst are contained in 100 parts by mass of the diene rubber. If the content of this polybutadiene rubber is less than 10 parts by mass, the effect of restraining the rubber composition from being changed in tackiness with time may become small. If the content is more than 80 parts by mass, the rubber composition may be lowered in tackiness. In order to make the tackiness of the rubber composition at an unvulcanized rubber stage especially good, in 100 parts by mass of the diene rubber, the polybutadiene rubber produced by use of the rare earth element based catalyst is contained in an amount preferably from 10 to 80 parts by mass, more preferably from 30 to 70 parts by mass.

The dihydrazide compound is a compound having, in the molecule thereof, two hydrazide groups (—CONHNH₂). Examples thereof include dihydrazide isophthalate, dihydrazide terephthalate, dihydrazide azelate, dihydrazide adipate, dihydrazide succinate, dihydrazide dieicosanoate, and 7,11-octadecadiene-1,18-dicarbohydrazide. Of these compounds, dihydrazide isophthalate and dihydrazide adipate are preferred, and dihydrazide isophthalate is particularly preferred in the present invention.

In the rubber composition according to the present invention, 0.1 to 5.0 parts by mass of the dihydrazide compound are blended for 100 parts by mass of the diene rubber. If the blend amount of the dihydrazide compound is less than 0.1 part by mass, the rubber composition may not be sufficiently improved in tackiness. If the blend amount is more than 5 parts by mass, the rubber composition may become too high so that products to be obtained through subsequent steps may be deteriorated in productivity, or other inconveniences may be caused. Considering the tackiness at the unvulcanized rubber stage, and the productivity of the products obtained through the steps subsequent to the kneading of the rubber composition, the blend amount of the dihydrazide compound is more preferably from 0.3 to 3 parts by mass.

The carbon black may be any carbon black usable in ordinary rubber industries, such as SAF, ISAF, HAF, FEF or GPF, or may be any electroconductive carbon black such as acetylene black or Ketjenblack.

In the rubber composition according to the present invention, 10 to 99 parts by mass of the carbon black are blended for 100 parts by mass of the diene rubber. The blend amount of the carbon black is more preferably from 20 to 80 parts by mass.

Besides the diene rubber, the carbon black, and the dihydrazide compound, for example, the following may be blended into the rubber composition according to the present invention: a vulcanization-related blending agent, another carbon black, silica, a silane coupling agent, an anti-aging agent, zinc oxide, stearic acid, a softening agent such as wax or oil, a processing aid, an organic acid metal salt, and a methylene acceptor and a methylene donor.

Examples of the organic acid metal salt include cobalt naphthenate, cobalt stearate, cobalt borate, cobalt oleate, cobalt maleate, and cobalt borate trineodecanoate.

The methylene acceptor may be a phenolic compound, or a phenolic resin, in which a phenolic compound is condensed with formaldehyde. Examples of this phenolic compound include phenol and resorcin; and respective alkyl derivatives thereof. Examples of the alkyl derivatives include methyl derivatives thereof, such as cresol and xylenol; and long-chain alkyl derivatives thereof, such as nonylphenol and octylphenol. The phenolic compound may be a phenolic compound having, as its substituent, an acyl group such as an acetyl group.

Examples of the phenolic resin, in which a phenolic compound is condensed with formaldehyde, include resorcin-formaldehyde resin, phenolic resin (phenol-formaldehyde resin), cresol resin (cresol-formaldehyde resin), and formaldehyde resins each made from plural phenolic compounds. These are each used in the form of an uncured resin having fluidity or thermal fluidity.

Of these methylene receptors, resorcin or a resorcin derivative is preferred from the viewpoint of the compatibility thereof with the rubber component or other components, the density of a resin obtained after the curing thereof, and the reliability. Particularly preferred is resorcin or resorcin-alkylphenol-formalin resin.

The methylene donor may be hexamethylenetetramine or a melamine resin. Examples of the melamine resin include methylolmelamine, a partially etherized product of methylolmelamine, and condensates each made from melamine, formaldehyde, and methanol. Of these methylene donors, particularly preferred is hexamethoxymethylmelamine.

The anti-aging agent may be any anti-aging agent usable ordinarily for rubbers. Examples thereof include aromatic amine type, amine-ketone type, monophenolic type, bisphenolic type, polyphenolic type, dithiocarbamic acid salt type, and thiourea type anti-aging agents. These may be used alone or in the form of an appropriate mixture. The content of the anti-aging agent(s) is preferably from 0.1 to 10 parts by mass, more preferably from 0.5 to 8 parts by mass for 100 parts by mass of the rubber component.

Examples of the vulcanization-related blending agent include vulcanizers such as sulfur and organic peroxides, vulcanization promoters, vulcanization promoting aids, and vulcanization retarders.

It is sufficient for the sulfur as the vulcanization-related blending agent that the species thereof is a sulfur species for ordinary rubbers. Examples thereof include powdery sulfur, precipitated sulfur, insoluble sulfur, and highly dispersed sulfur. Considering physical properties and the endurance of the vulcanized rubber composition, and others, the blend amount of the sulfur vulcanizer is preferably from 0.1 to 15 parts by mass for 100 parts by mass of the rubber component in terms of the sulfur amount.

The vulcanization promoters may each be a vulcanization promoter usable usually for rubber vulcanization, and examples thereof include sulfenamide type, thiuram type, thiazole type, thiourea type, guanidine type, and dithiocarbamic acid salt type vulcanization promoters. These may be used alone or in the form of an appropriate mixture. The blend amount of used one(s) of these vulcanization promoters is preferably from 0.1 to 10 parts by mass for 100 parts by mass of the rubber component.

The rubber composition according to the present invention is obtained by using a kneading machine usable in ordinary rubber industries, such as a Banbury mixer, a kneader or a roll, to knead a diene rubber, a carbon black and a dihydrazide compound, and one or more optional components, such as a sulfur vulcanizer, a vulcanization promoter, silica, a silane coupling agent, zinc oxide, stearic acid, a vulcanization promoting aid, a vulcanization retardant, an organic peroxide, an anti-aging agent, a softening agent such wax or oil, and a processing aid.

The method for blending the above-mentioned individual components with each other is not particularly limited, and may be, for example, a method of kneading the blending components other than any vulcanization-related blending agent, such as the sulfur vulcanizer and the vulcanization promoter, beforehand to prepare a master batch, adding thereto the rest of the individual components, and further kneading all the components, a method of adding the individual components in any order into a kneading machine, and then kneading all the components, or a method of adding all the components simultaneously into a kneading machine.

### EXAMPLES

Hereinafter, a description will be made about examples demonstrating the subject matter and the advantageous effects of the present invention, and others. About items for evaluating a rubber composition of each of the examples and the others, the following sample was evaluated on the basis of evaluating-methods described below: a rubber sample obtained by heating the rubber composition at 150° C. for 30 minutes to be vulcanized.

(1) Tanδ (low thermogenic performance)

A viscoelastic spectrometer manufactured by Toyo Seiki Seisaku-Sho, Ltd. is used to measure the tanδ of the sample at an initial strain of 10%, a dynamic strain of 2%, a frequency of 50 Hz and a temperature of 60° C. The low thermogenic performance thereof is evaluated on the basis of the tanδ value. About each of Comparative Examples 2 to 5 and Examples 1 to 5, the evaluation is made by regarding the value of Comparative Example 1 as 100, and obtaining an index of the sample, which is relative to the value of Comparative Example 1. About each of Comparative Examples 7 and 8 and Examples 6 and 7, the evaluation is made by regarding the value of Comparative Example 6 as 100, and obtaining an index of the sample, which is relative to the value of Comparative Example 6. As the resultant numerical value is smaller, the sample is better in low thermogenic performance.

### (2) Tackiness

An instrument, Picma Tack Tester, manufactured by Toyo Seiki Seisaku-Sho, Ltd. is used to measure the tackiness of the sample under conditions that the temperature is room temperature, the compression period is 0 second, and the raising rate is 300 mm/min. About each of Comparative Examples 2 to 5 and Examples 1 to 5, the evaluation is made by regarding the value of Comparative Example 1 as 100, and obtaining an index of the sample, which is relative to the value of Comparative Example 1. About each of Comparative Examples 7 and 8 and Examples 6 and 7, the evaluation is made by regarding the value of Comparative Example 6 as 100, and obtaining an index of the sample, which is relative to the value of Comparative Example 6. As the resultant numerical value is larger, the sample is larger in tackiness just after the rubber composition is made into the shape of this sample, so as to be better in tackiness. Furthermore, the sample is allowed to stand still at room temperature for one week. A measurement is then made about the difference between the tackiness just after the shaping and that after the standing-still for the one week. As this difference is smaller, the sample is further restrained from being changed in tackiness with time.

### Preparation of Rubber Compositions:

Rubber components and blending agents for each of Examples 1 to 7 and Comparative Examples 1 to 8 were mixed with each other in accordance with a blend formulation shown in Tables 1 and 2. An ordinary Banbury mixer was used to knead the resultant mixture to prepare a rubber composition. Details of each of the rubber components and the blending agents shown in Tables 1 and 2 are described below (in these tables, the blend amount of each of the blending agents is shown as the number of parts by mass thereof for 100 parts by mass of the rubber components in each of the examples).

a) Diene rubbers:

Natural rubber (NR): product “RSS #3”, and

Polybutadiene rubbers (BRs):
(A) polybutadiene rubber produced by use of a cobalt based catalyst, “BR150L”, manufactured by Ube Industries, Ltd., and
(B) polybutadiene rubber produced by use of a neodymium based catalyst, “CB22”, manufactured by Lanxess
   b) Carbon black (HAF-HS): product, “SEAST KH”, manufactured by Tokai Carbon Co., Ltd.
   c) Process oil: product, “PROCESS NC140”, manufactured by a company, JX Nippon Oil & Energy
   d) Dihydrazide compound: dihydrazide isophthalate (IDH), produced by Japan Finechem Inc.
   e) Stearic acid: product, “LUNAC S20”, manufactured by Kao Corporation.
   f) Zinc oxide: product, “AENKA No. 1”, manufactured by Mitsui Mining and Smelting Co., Ltd.
   g) Anti-aging agent: product, “ANTIGEN 6C”, manufactured by Sumitomo Chemical Co., Ltd.
   h) Wax: product, “SUNNOC N”, manufactured by Ouchi Shinko Chemical Industry Co., Ltd.
   i) Sulfur: powdery sulfur, manufactured by Tsurumi Chemical Industry Co., Ltd.
   j) Vulcanization promoter: product, “SOXINOL CZ”, manufactured by Sumitomo Chemical Co., Ltd.

TABLE 1

| | | Comparative | Comparative | Comparative | Comparative | Comparative | Exam- | Exam- | Exam- | Exam- | Exam- |
|---|---|---|---|---|---|---|---|---|---|---|---|
| | | Example 1 | Example 2 | Example 3 | Example 4 | Example 5 | ple 1 | ple 2 | ple 3 | ple 4 | ple 5 |
| NR | | 70 | 70 | 70 | 70 | 70 | 70 | 70 | 70 | 40 | 30 |
| BR (A) | | 30 | — | 30 | — | — | — | — | — | — | — |
| BR (B) | | — | 30 | — | 30 | 30 | 30 | 30 | 30 | 60 | 70 |
| Carbon black | | 50 | 50 | 50 | 50 | 50 | 50 | 50 | 50 | 50 | 50 |
| Oil | | 10 | 10 | 10 | 10 | 10 | 10 | 10 | 10 | 10 | 10 |
| Dihydrazide isophthalate | | — | — | 0.5 | 0.05 | 7 | 0.5 | 0.2 | 3 | 0.5 | 0.5 |
| Stearic acid | | 2.0 | 2.0 | 2.0 | 2.0 | 2.0 | 2.0 | 2.0 | 2.0 | 2.0 | 2.0 |
| Zinc flower | | 2.0 | 2.0 | 2.0 | 2.0 | 2.0 | 2.0 | 2.0 | 2.0 | 2.0 | 2.0 |
| Anti-aging agent | | 2.0 | 2.0 | 2.0 | 2.0 | 2.0 | 2.0 | 2.0 | 2.0 | 2.0 | 2.0 |
| Wax | | 2.0 | 2.0 | 2.0 | 2.0 | 2.0 | 2.0 | 2.0 | 2.0 | 2.0 | 2.0 |
| Vulcanization promoter | | 1.5 | 1.5 | 1.5 | 1.5 | 1.5 | 1.5 | 1.5 | 1.5 | 1.5 | 1.5 |
| Sulfur | | 1.5 | 1.5 | 1.5 | 1.5 | 1.5 | 1.5 | 1.5 | 1.5 | 1.5 | 1.5 |
| Tackiness | Value just | 100 | 98 | 106 | 99 | 130*⁾ | 111 | 109 | 118 | 109 | 108 |
| values | after shaping | | | | | | | | | | |
| | into sample | | | | | | | | | | |
| | Value after | 89 | 96 | 91 | 96 | 116 | 105 | 105 | 110 | 105 | 105 |
| | standing-still | | | | | | | | | | |
| | at room | | | | | | | | | | |
| | temperature | | | | | | | | | | |
| | for one week | | | | | | | | | | |
| | Difference | 11 | 2 | 15 | 3 | 14 | 6 | 4 | 8 | 4 | 3 |

| | | | | | | | | | | |
|---|---|---|---|---|---|---|---|---|---|---|
| Low thermogenic performance | 100 | 88 | 87 | 84 | 70 | 76 | 80 | 73 | 73 | 72 |

*⁾Not good because rubber-products to be obtained were deteriorated in productivity; for example, the rubber composition was too high in tackiness force so that when the composition in an unvulcanized state was made into the form of piled sheets, the sheets were not easily separated from each other.

TABLE 2

| | | Comparative | Comparative | Comparative | | |
|---|---|---|---|---|---|---|
| | | Example 6 | Example 7 | Example 8 | Example 6 | Example 7 |
| NR | | 30 | 30 | 30 | 30 | 30 |
| BR (A) | | 70 | — | 70 | — | — |
| BR (B) | | — | 70 | — | 70 | 70 |
| Carbon black | | 65 | 65 | 65 | 65 | 65 |
| Dihydrazide isophthalate | | — | — | 0.5 | 0.5 | 3.0 |
| Stearic acid | | 2.0 | 2.0 | 2.0 | 2.0 | 2.0 |
| Zinc flower | | 2.0 | 2.0 | 2.0 | 2.0 | 2.0 |
| Anti-aging agent | | 2.0 | 2.0 | 2.0 | 2.0 | 2.0 |
| Vulcanization promoter | | 2.0 | 2.0 | 2.0 | 2.0 | 2.0 |
| Sulfur | | 4.0 | 4.0 | 4.0 | 4.0 | 4.0 |
| Tackiness | Value just after | 100 | 95 | 103 | 105 | 110 |
| values | shaping into sample | | | | | |
| | Value after | 85 | 92 | 81 | 103 | 107 |
| | standing-still at | | | | | |
| | room temperature | | | | | |
| | for one week | | | | | |
| | Difference | 15 | 3 | 22 | 2 | 3 |

| | | | | | |
|---|---|---|---|---|---|
| Low thermogenic performance | 100 | 83 | 84 | 75 | 71 |

What is claimed is:

1. A rubber composition, comprising: a diene rubber containing at least a polybutadiene rubber produced by use of a rare earth element based catalyst; a carbon black in an amount of 10 to 99 parts by mass for 100 parts by mass of the diene rubber; and a dihydrazide compound in an amount of 0.1 to 5.0 parts by mass for the same.

2. The rubber composition according to claim 1, wherein 10 to 80 parts by mass of the polybutadiene rubber are contained in 100 parts by mass of the diene rubber.

3. The rubber composition according to claim 1, wherein the rare earth element based catalyst is a neodymium based catalyst.

4. A pneumatic tire, comprising at least one selected from the group consisting of a cap tread, a base tread, a sidewall, a rim strip, and a side pad of a run flat tire which are each obtained by use of the rubber composition recited in claim 1.
